(19) United States
(12) Patent Application Publication
(10) Pub. No.: US 2024/0112009 A1
(43) Pub. Date: Apr. 4, 2024

(54) MULTI-DIMENSIONAL GEOMETRIC WIRELESS CHANNEL RENDERING USING MACHINE LEARNING MODELS

(71) Applicant: QUALCOMM Incorporated, San Diego, CA (US)

(72) Inventors: Tribhuvanesh OREKONDY, Biel (CH); Arash BEHBOODI, Amsterdam (NL); Kumar PRATIK, Amsterdam (NL); Joseph Binamira SORIAGA, San Diego, CA (US); Shreya KADAMBI, San Diego, CA (US)

(21) Appl. No.: 17/935,046

(22) Filed: Sep. 23, 2022

(51) Int. Cl. G06N 3/08; H04B 17/391

(52) U.S. Cl. CPC G06N 3/08; H04B 17/391

(57) ABSTRACT

Certain aspects of the present disclosure provide techniques and apparatus for training and using machine learning models to estimate a layout of a spatial area. An example method generally includes estimating a representation of a channel using a machine learning model trained to generate the estimated representation of the channel based on a location of a transmitter in a spatial environment, a location of a receiver in the spatial environment, and a three-dimensional representation of the spatial environment. One or more actions are taken based on the estimated representation of the channel.

### INTRODUCTION

Aspects of the present disclosure relate to using machine learning models to estimate a wireless channel.

In a wireless communications system, a transmitter and a receiver communicate by transmitting signals to each other over a wireless channel which may be represented as components received at a receiver on a given frequency band. Information about a wireless channel can be used for various purposes. For example, information about the wireless channel can be used to identify various parameters for communications between a transmitter and a receiver, such as beamforming parameters, directional beam selection, and the like. Information about a wireless channel can also be used to determine the layout of a spatial environment in which the transmitter and receiver are located, which in turn may be used for various purposes such as detecting entry and exit of devices into different areas (e.g., defined based on a radius from a given device). Layout information and location estimation can be used for many other purposes as well, such as emergency management within the spatial area, spatial optimization, and the like.

The state of a wireless channel may generally depend on various factors in the spatial environment. For example, a wireless channel may be affected by sources of radio frequency interference, such as interfering network entities. In another example, hard surfaces, such as walls, support columns, or the like, and the materials in these environments, may introduce attenuation and reflections of radio waves in radio frequency measurements obtained within the spatial area. Because the state of a wireless channel may depend on many factors that are different across different environments, it may be difficult to estimate the state of a wireless channel.

Accordingly, what is needed are improved techniques for estimating a wireless channel in a spatial environment.

### BRIEF SUMMARY

One aspect provides a method for estimating a wireless channel using a machine learning model. An example method generally includes estimating a representation of a channel using a machine learning model trained to generate the estimated representation of the channel based on a location of a transmitter in a spatial environment, a location of a receiver in the spatial environment, and a three-dimensional representation of the spatial environment. One or more actions are taken based on the estimated representation of the channel.

Another aspect provides a method for training a machine learning model to estimate a wireless channel. An example method generally includes generating a training data set including a plurality of channel representations. Each channel representation generally includes information for a plurality of rays corresponding to paths between a transmitter and a receiver in a spatial environment. A machine learning model is trained to generate an estimated representation of a channel based on a three-dimensional representation of the spatial environment and the training data set.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts signals transmitted between a transmitter and multiple receivers in a spatial environment.

FIG. 2 depicts an example pipeline for estimating a wireless channel using a machine learning model, according to aspects of the present disclosure.

FIGS. 3A and 3B depict examples of a ray propagation estimation stage including one or more machine learning models that estimates propagation of rays in a wireless channel and reception or termination of propagated rays in the wireless channel, according to aspects of the present disclosure.

FIG. 4 depicts an example of a ray-surface interaction block for modeling interactions between rays and surfaces during ray propagation, according to aspects of the present disclosure.

FIG. 5 depicts an example of blind launching of a set of rays from a transmitter, including a subset of rays that contribute to signal reception at a receiver, according to aspects of the present disclosure.

FIG. 6 depicts a ray launching model which launches rays that contribute to signal reception at a receiver, according to aspects of the present disclosure.

FIG. 7 depicts example operations for estimating a layout of a spatial area based on a machine learning model and an input data set of multidimensional samples from the spatial area, according to aspects of the present disclosure.

FIG. 8 depicts example operations for training a machine learning model to estimate a layout of a spatial area based on an input data set of multidimensional samples from the spatial area, according to aspects of the present disclosure.

FIG. 9 depicts an example implementation of a processing system on which a machine learning model is trained to estimate a layout of a spatial area, according to aspects of the present disclosure.

FIG. 10 depicts an example implementation of a processing system on which a machine learning model is used to estimate a layout of a spatial area, according to aspects of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide techniques for estimating a channel between a transmitter and a receiver based on positional information for the transmitter and the receiver and the layout of the spatial area in which the transmitter and receiver are operating. Such estimation may be performed, for example, using a machine learning model trained to generate an estimation of a channel based on positional information for the transmitter and the receiver and the layout of the spatial area in which the transmitter and receiver are operating.

Information about a channel, such as an estimate of the channel at a receiver, can be used for various tasks within a wireless communications system and/or within systems that use devices that communicate within a wireless communications system. For example, the information about a channel can be used for signal management, such as beamforming or beam selection, for communications between the transmitter and the receiver. In another example, information about a channel can be used for various sensing tasks, such as location estimation, floormap estimation, or the like. This information may, in turn, be used to determine how a spatial area is to be used, to generate a virtual reality or extended reality scene in the spatial area, for traffic management within the spatial area, for location estimation, and the like. In still further examples, learnt positions of signal reflectors in a spatial environment and the signal reflection properties of these reflectors, can be used to perform various tasks in dynamic environments, such as autonomous driving or other autonomous operations in which the state of the environment continually changes.

Various techniques can be used to estimate information about a channel, given information about the location of a transmitter and the location of a receiver in a spatial environment. For example, neural statistical models, implemented as deep neural networks (DNNs), can be used to generate an estimation of a channel based on various field measurements for the transmitter and receiver. These models may allow for the estimation of a channel in various generic scenarios with minimal, or at least relatively very low, computational expense. However, the channel estimates generated by these models may reflect channel estimates in a generic environment and may not take into account environment-specific properties that affect the state of the channel at the receiver. For example, these generic models may not take into account reflections of signals off of surfaces within a spatial environment, signal attenuation due to these reflections, signal attenuation and reflectivity properties of different materials used within a spatial environment, and the like.

Aspects of the present disclosure provide techniques that allow for a channel to be estimated based on a spatially consistent machine learning model that takes into account information about the environment in which a transmitter and receiver operates in estimating information about the channel. By doing so, aspects of the present disclosure can generate accurate estimations of a channel between a transmitter and a receiver in any given environment. These estimations of a channel may take into account different components of a wireless signal that are received at the receiver at different times due to different propagation paths within the spatial environment and can disregard signal components that have minimal impact on the overall received channel at the receiver.

By accurately estimating a channel in a spatial environment, aspects of the present disclosure may allow for improved accuracy in applications that use estimates of a channel to perform various tasks. For example, the accurate channel estimations generated by the machine learning models discussed herein may allow for improved communications in various spatial environments and at various frequencies at which transmitters and receivers communicate, as these accurate channel estimations may be used to identify blockages within the spatial environment that degrade a wireless signal, to estimate optimal beams to use in high-frequency (e.g., millimeter wave (mmWave)) communications between a transmitter and a receiver, and the like. Further the machine learning models discussed herein may allow for propagation of a signal between a transmitter and a receiver to be modeled, which may allow for information about the spatial environment, such as the presence of reflective or refractive surfaces in the spatial environment and the radio frequency reflectivity and attenuation properties of these surfaces, to be obtained from the estimation of the channel generated by these machine learning models.

### Example Radio Frequency Signals in a Spatial Area

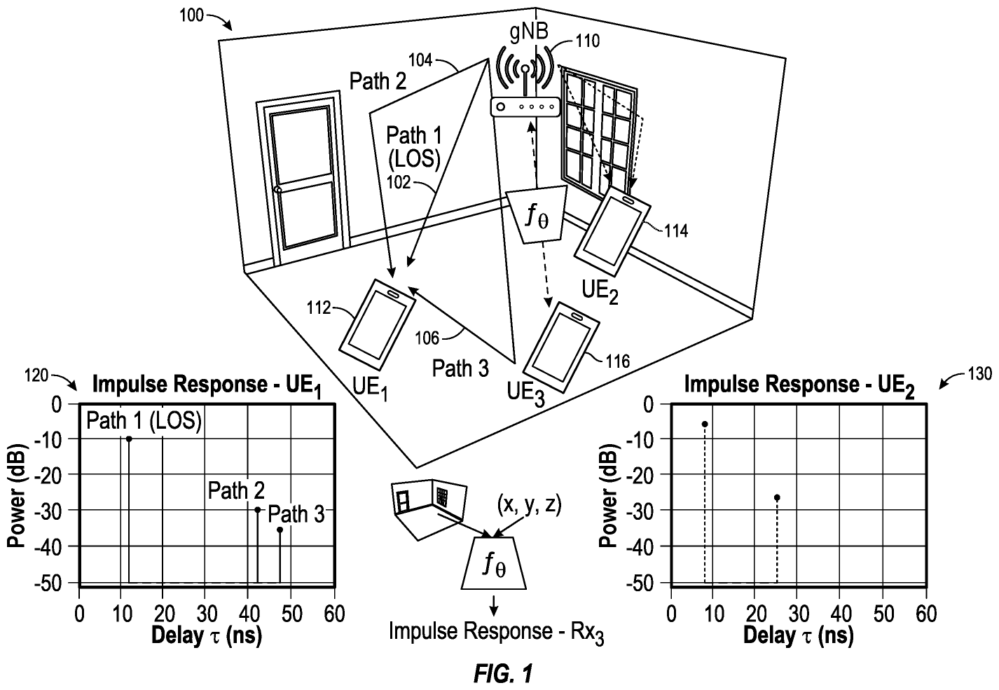

FIG. 1 illustrates example signals transmitted between a transmitter and various receivers within a spatial environment.

As illustrated, within spatial environment 100, a transmitter 110 transmits signals to receivers 112, 114, and 116. Transmitter 110 may be, for example, a gNodeB in a cellular telecommunications system, and receivers 112, 114, and 116 may be user equipments (UEs) serviced by the gNodeB.

Because spatial environment 100 includes various surfaces from which signals can be reflected, such as walls, floors, ceilings, or other surfaces, signaling transmitted between a transmitter 110 and receivers 112, 114, and 116 may include a line-of-sight (LOS) component and, in some cases, one or more non-LOS components. For example, as illustrated, a signal received at receiver 112 includes an LOS component corresponding to Path 1 102, a first non-LOS component corresponding to Path 2 104 in which receiver 112 receives the reflection of the signal off of a wall in spatial environment 100, and a second non-LOS component corresponding to Path 3 106 in which receiver 112 receives the reflection of the signal off of a floor in spatial environment 100. Similarly, a signal received at receiver 114 includes an LOS component and a non-LOS component in which receiver 114 receives the reflection of the signal off of a wall in spatial environment 100.

Because a receiver can receive a signal including an LOS component and non-LOS components, a total impulse response (or signal strength) f a for any signal transmitted by transmitter 110 may thus include the impulse response for the LOS component and the impulse responses for the non-LOS components. As illustrated in impulse response plot 120 for receiver 112 and impulse response plot 130 for receiver 114, the LOS component may have the highest impulse response and shortest delay between transmission by transmitter 110 and reception by the appropriate receiver, and the non-LOS components may have lower impulse responses and longer delays between transmission and reception relative to the LOS components. These non-LOS components may have lower impulse responses due to various factors, including signal attenuation from the surfaces from which these signals reflect, as different surfaces may introduce different amounts of signal attenuation into a non-LOS component, and the total distance traversed between a transmitter and a receiver, as signal strength generally decreases as a function of distance.

Generally, a global representation of a wireless channel can be modeled by the equation:

$$y ( t ) = {\sum }_{i} {a}_{i} ( t ) x ( t - {τ}_{i} ( t ) )$$

where y(t) is the global representation of the channel at time t, aᵢ represents the gain for the i^{th} path and τᵢ represents the delay for the i^{th} path. This global representation illustrates that the wireless channel is the aggregate of signals received at the receiver for each path from the transmitter to the receiver (e.g., for both the LOS and non-LOS components). However, this global representation may not allow for the propagation properties of a signal on any given path to be modeled. More specifically, for a given path, the global representation may not allow for reflection and signal attenuation to be modeled for any non-LOS component of the signal.

To account for various properties of three-dimensional spatial environments that influence signal reflection and signal attenuation, and to allow for channel estimation within various spatial environments based on signal measurements obtained for a received signal within a spatial environment, aspects of the present disclosure provide techniques for estimating a representation of a channel using a neural network based on the locations of transmitters and receivers within a spatial environment and three-dimensional representations of the spatial environment. As discussed in further detail herein, a neural network may estimate a channel based on estimations of signal attenuation due to propagation distance and of signal attenuation due to ray-surface interactions (e.g., signal absorption, reflection angle, etc.). The overall channel may be rendered based on these estimations such that the channel includes signal components that are deemed to have been received by the receiver (e.g., propagate to points within a defined reception ellipsoid for the receiver) and excludes signal components that have an insignificant impact on the overall channel due to attenuation below a threshold signal strength.

### Example Estimation of a Wireless Channel Using Machine Learning Models

Within a wireless communication system, a signal may be represented as a series of rays emitted from a location within a spatial environment of a transmitter and received if a signal reaches a reception ellipsoid (e.g., a sphere or non-spherical three-dimensional figure with an elliptical shape) defined as a location of a receiver within the spatial environment and a radius from this location. To model a signal, a surface of an ellipsoid around a transmitter may be tessellated into a collection of surfaces (e.g., arcs, circles, polygons, etc.), and rays may be launched from the transmitter omnidirectionally, with each ray corresponding to a specific surface from the collection of surfaces. As discussed in further detail, each ray may be traced until the ray meets specified termination criteria (e.g., exits the spatial environment, reaches a defined maximum number of reflections or diffractions, etc.), the signal strength of the ray falls below a threshold strength, or until the ray reaches the reception ellipsoid, which may be defined as a sphere with a radius of

$$\frac{α d}{\sqrt{3}} ,$$

where α represents the angle between adjacent rays transmitted by the receiver and d represents the ray length. Generally, the choice of α and the corresponding sphere radius represents a tradeoff between accuracy and complexity; smaller values of a may result in the generation of more rays to be traced, with a corresponding increase in accuracy and complexity, while larger values of a may result in the generation of fewer rays to be traced, with a corresponding decrease in accuracy and complexity.

To parameterize a ray and allow a machine learning model to be trained to “propagate” a ray, defined as uₖ, an impulse response f_{θ} may be defined according to the expression: f_{θ}: F×uₖ^{(r)} [symbol] uₖ^{(r+1)}, where F represents the spatial environment and uₖ^{(r)} represents the state of a ray after r interactions within the spatial environment. Environment F may be represented in various manners, such as a series of vertices V, a series of polygonal (e.g., triangular) faces, F, a three-dimensional mesh (defined as a collection of vertices V and faces F) or the like. Generally, spatial environment F may correspond to a specific geometry and may not embed information about the materials within the spatial environment.

A ray uₖ^{(r)} may be represented as a collection of data, including geometry, signal properties, and state information. The geometric information may include information about the location x^{(r)} of a ray at the r^{th} interaction, the distance d traveled from an origin point (e.g., the location of the transmitter) to x^{(r)}, a location tᵣₓ at which a signal intersects the reception ellipsoid, a location tₛ at which the signal reaches a reflection point, and the definition of the reception ellipsoid rxᵣ. The signal properties may include gain information a, time of flight information τₖ for the k^{th} ray, an angle of departure θ_{DOD}^{(r)} representing the direction of departure of a ray from a transmitter, and an angle of arrival θ_{DOA}^{(r)} A representing the direction of arrival of the ray at a receiver. Finally, the state information may include the state of the signal σ_{upd}^{(r)} and the state of the receiver σᵣₓ^{(r)} at the r^{th} interaction.

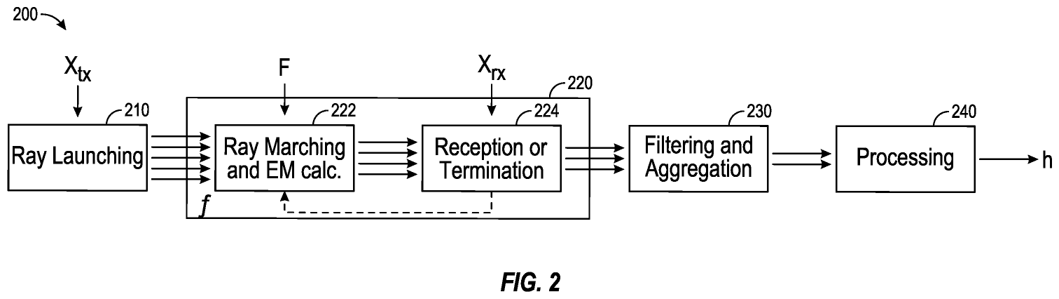

FIG. 2 illustrates an example pipeline 200 for estimating a wireless channel using a machine learning model, according to aspects of the present disclosure. As illustrated, pipeline 200 includes a ray launching stage 210, a ray propagation estimation stage 220, a filtering and aggregation stage 230, and a processing stage 240.

At ray launching stage 210, information about the location of the transmitter, denoted as xₜₓ, may be used to launch a plurality of rays. In some aspects, rays launched from location xₜₓ may be launched blindly, in which the transmitter is approximated as an icosphere (or a geodesic polyhedron in which an ellipsoid, such as a sphere, corresponding to the transmitter is modeled as a collection of polygonal (e.g., triangular) faces from which rays are launched. In some aspects, rays may be launched from the transmitter at ray launching stage 210 based on a learned launching scheme, in which one or more models are used to identify a set of relevant rays to launch based on a likelihood that rays will reach a reception ellipsoid with a sufficient received signal strength.

For each ray launched at ray launching stage 210, a ray propagation estimation stage 220 propagates the ray within a spatial environment F via ray marcher 222 and determines, at reception/termination block 224, whether the ray has reached a reception ellipsoid or a termination condition indicating that the ray will not meaningfully contribute to the impulse response for a received signal at the receiver.

Subsequently, at filtering and aggregation stage 230, rays may be filtered based on whether these rays are received at the reception ellipsoid. The filtering may be performed based on the received power of a ray when the ray enters a reception ellipsoid and based on a number of ray-surface interactions, such as reflections and/or refractions from a surface in the spatial environment F. Generally, a ray may be deemed to have been received by a receiver if a ray enters the reception ellipsoid of the receiver with a signal power that exceeds a threshold level, If the ray enters the reception ellipsoid of the receiver with a signal power that falls below this threshold, then the ray may be deemed to not meaningfully contribute to the impulse response for the received signal and may be disregarded. Further, because each ray-surface interaction (e.g., reflection and/or refraction caused by a surface in the spatial environment F) attenuates a signal, a maximum number of ray-surface interactions may be defined for signals that meaningfully contribute to the impulse response for the received signal. If the number of ray-surface interactions estimated for a ray exceeds a threshold number of ray-surface interactions, then the ray may be disregarded in generating a representation of a channel.

At processing stage 240, the rays identified at filtering and aggregation stage 230 as relevant to the impulse response at a receiver may be aggregated. This aggregation may be the estimated representation h of a channel within spatial environment F for a transmitter located at xi, and a receiver located at xᵣₓ.

To generate this estimated representation of the channel, a renderer implemented via pipeline 200 may be trained to minimize pointwise channel losses. For example, machine learning models used to implement pipeline 200 may be trained according to the expression:

$$min {\sum }_{i} {ℒ}_{c h a n} ( {\hat{h}}_{i} , {h}_{i} )$$

where hᵢ represents the actual state of a channel and ĥᵢ represents the estimated (rendered) state of a channel, given inputs of the location xᵣₓ of the receiver, the location xₜₓ of the transmitter, and the layout F of the spatial environment. The loss function minimized may be, for example, a Chamfer distance or other distance that measures a difference between the actual and estimated (rendered) state of the channel.

To train the machine learning model implemented via pipeline 200, a data set including a plurality of channel representations may be generated. Each channel representation may include a plurality of sets of vectors, with each set of vectors from the plurality of sets corresponding to a specific path between the transmitter and the receiver in the spatial environment F. To reduce the size of the data set, masking may be used to remove irrelevant vectors from each set of vectors. Generally, an irrelevant vector, and thus one that may be masked prior to training the machine learning model, may correspond to points at which a ray has a signal strength below a threshold power, and thus points at which a ray is deemed to no longer meaningfully contribute to the channel impulse response at the receiver.

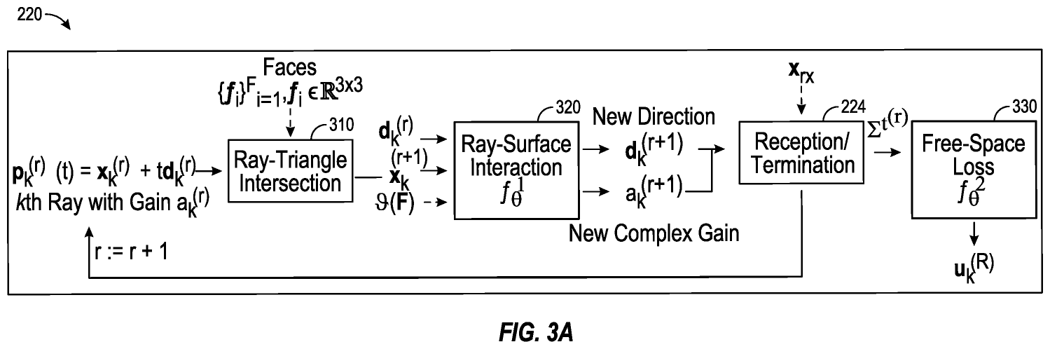

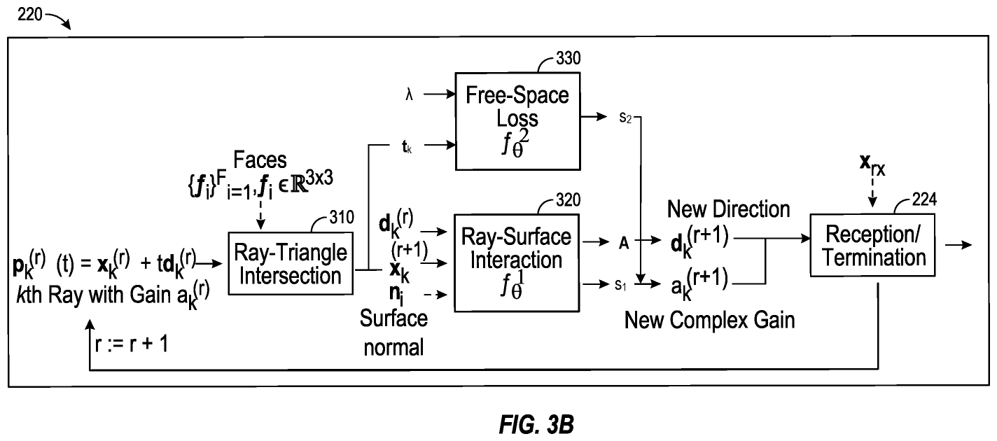

FIG. 3A depicts an example of a ray propagation estimation stage 220 including one or more machine learning models that estimate propagation of rays in a wireless channel and reception or termination of propagated rays in the wireless channel, according to aspects of the present disclosure.

As illustrated, to estimate propagation of a ray, a k^{th} ray with gain aₖ^{(r)}, represented as pₖ^{(r)}(t)=xₖ^{(r)}+tdₖ^{(r)}, and layout F of spatial environment are input into ray-triangle intersection block 310. Ray-triangle intersection block 310 determines the next location of a ray, given the current direction and current position of the ray, in relation to a specific face within a spatial environment and, if so, how the ray interacts with that face. The faces in F may be defined as {fᵢ}ᵢ₌₁^{F}, fᵢ∈ [symbol] . Generally, in determining whether a ray interacts with a specific face within a spatial environment, ray-triangle intersection block 310 can solve for tₘᵢₙ in the equation: xₖ⁽¹⁾=xₖ⁽⁰⁾+tₘᵢₙdₖ⁽⁰⁾.

The new location of the ray, as well as a distance from a previous ray location, are then input into ray-surface interaction block 320. Ray-surface interaction block 320 generally uses the estimated direction and location information to determine whether a ray is expected to interact with a surface (e.g., reflect and/or refract from a surface). Generally, the output of ray-surface interaction block 320 may be a new direction dₖ^{(r+1)} and gain aₖ^{(r+1)}. To generate the new direction dₖ^{(r+1)} and gain aₖ^{(r+1)}, ray-surface interaction block 320 can use a spatial model and a directional model to estimate how a ray will reflect or refract relative to a surface in spatial environment F and the signal attenuation imposed as a result of the reflection or refraction relative to the surface.

After propagation and a determination at ray-surface interaction block 320 of whether a ray interacts with a surface in spatial environment F, reception/termination block 224 determines whether a beam has been received or is terminated. Generally, a beam is deemed to have been received if the estimated location of the beam is on the surface of the reception ellipsoid or inside the reception ellipsoid. To determine whether a beam is terminated, as discussed above, reception/termination block 224 can use a threshold number of ray-surface interactions and/or a threshold signal strength (or amount of gain) to determine whether a beam meaningfully contributes to the impulse response for a channel received at the receiver. Generally, if the estimated signal strength (or gain) for a beam falls below a threshold, or if a signal has interacted with a surface more than a threshold number of times, it may be determined that the beam does not materially contribute to the overall impulse response for a signal at the receiver and thus that the beam can be disregarded going forward.

At free-space loss block 330, signal attenuation due to propagation distance, independent of reflections from surfaces within the spatial environment, may be modeled in order to generate an estimation of the state of the ray at a receiver. Free space loss may be represented by Friis' Equation:

$${P}_{r} ( d ) = {P}_{t} {K ( \frac{{d}_{0}}{d} )}^{λ} , d \geq d {0}_{0} .$$

In the equation above, K, d₀, and λ may be learnable parameters. K generally corresponds to a learned constant representing antenna gain, d₀ corresponds to a learned reference distance, and λ corresponds to a learned signal wavelength. Pᵣ represents the power received at a receive antenna for a given ray as a function of the power Pₜ input into the transmitting antenna and the distance d traveled by the given ray.

FIG. 3B illustrates another example of a ray propagation estimation stage 220 including one or more machine learning models that estimate propagation of rays in a wireless channel and reception or termination of propagated rays in the wireless channel, according to aspects of the present disclosure. In this example, the next location of a ray generated by ray-triangle intersection block 310, as well as a distance from a previous ray location, may be input into ray-surface interaction block 320. Meanwhile, carrier wavelength λ and timing information tₖ generated by the ray-triangle intersection block 310 may be input into free-space loss block 330. Ray-surface interaction block 320 generates a three-dimensional rotation A∈ [symbol] , conditioned on an incidence point xₖ^{(r+1)} and incident angle dₖ^{(r)} and surface attenuation s₁, corresponding to the amount of attenuation caused by a surface with which a ray interacts. Meanwhile, the free-space loss block 330 uses the carrier wavelength λ and timing information tₖ to calculate the effects s₂ of free-space antenna gains, path losses, and phase changes for a given ray and the distance between two points tₖ=∥xₖ^{(r+1)}−xₖ^{(r)}∥. Generally, free-space loss block 330 may calculate s₂ using a complementary neural network that learns the free-space effects on a ray, including free-space antenna gain, path loss, and phase change properties of rays in a given spatial environment. This complementary neural network may be represented by the expression: f_{θ}²:tₖ×λ_{c} [symbol] s₂. As illustrated, the rotation A, surface attenuation s₁, and free-space effects s 2 may be input into reception/termination block 224 to determine whether a ray is received at a receiver (e.g., enters the reception ellipsoid defined for a receiver in the spatial environment) or is terminated (e.g., has a signal strength below a threshold level, indicating that the ray will not meaningfully contribute to an impulse response at the receiver).

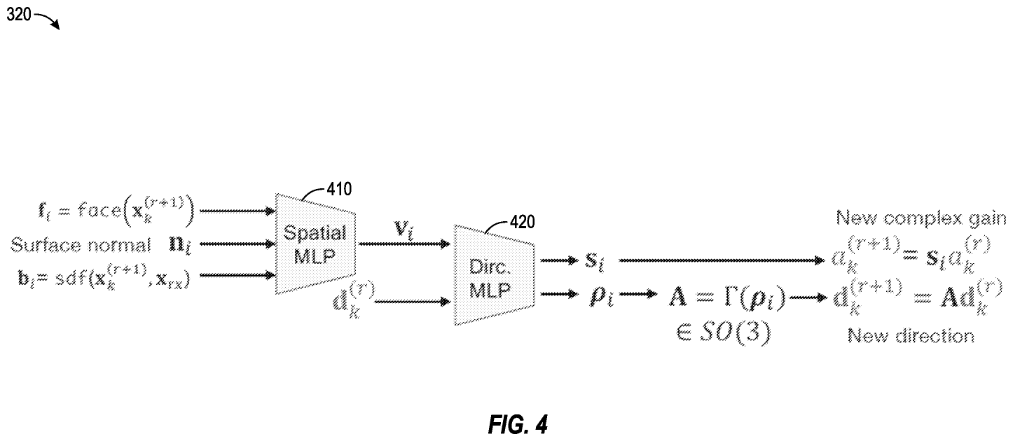

FIG. 4 illustrates an example of a ray-surface interaction block 320 used to model the interaction between rays and surfaces in a spatial environment during propagation of a ray, according to aspects of the present disclosure. As illustrated, ray-surface interaction block 320 includes a spatial multilayer perceptron (MLP) 410 and a directional MLP 420. Ray-surface interaction network generally estimates, for a given ray originating at xₖ^{(r)} and traveling in direction dₖ^{(r)} that interacts with a surface (or face fᵢ=face(xₖ^{(r+1)})) in a spatial environment the resulting outgoing ray. The outgoing ray may be modeled as an estimation of the new direction dₖ^{(r+1)} of the ray and the corresponding change of gain arising from the collision with the surface in the spatial environment. Because the direction and change in gain of a ray after interaction with a surface generally depends on the electromagnetic properties (reflection, refraction, scattering, absorption, etc.) of the material from which the surface is composed, aspects of the present disclosure may learn these properties by associating spatial regions in the environment with specific electromagnetic properties.

The spatial MLP 410 and directional MLP 420 are generally configured to associate spatial coordinates with the electromagnetic properties of specific surfaces in the spatial environment by mapping spatial properties (e.g., a face corresponding to a location xₖ^{(r+1)}) with properties such as a gain factor. As illustrated, spatial MLP 410 may encode electromagnetic properties specific to a spatial region but independent of an incidence direction, while directional MLP 420 predicts the rotation imposed on a ray incident with direction dₖ^{(r)} on face fᵢ. Spatial MLP 410 may generate a spatial vector vᵢ based on an input of a one-hot encoding of a face fᵢ on which point xₖ^{(r+1)} lies, a surface normal vector nᵢ at point xₖ^{(r+1)} and a three-dimensional vector of signed distances bᵢ=sdf(xₖ^{(r+1)},xᵣₓ), where sdf represents the signed distance function between a coordinate x and face f. The output of spatial MLP 410 may be provided as an input, along with direction dₖ^{(r)}, into directional MLP 420, which estimates a gain factor sᵢ and rotation σᵢ. The resulting complex gain of a ray uₖ^{(r+1)} may be modeled as sₖ^{(r+1)}=sᵢsₖ^{(r)}. The predicted rotation σᵢ may be generated based on Euler-Rodrigues parameterization which encodes the axis of rotation about which dₖ^{(r)} rotates by angle θ. This rotation may be represented by a matrix A such that the new direction of ray k is defined as dₖ^{(r+1)}=Adₖ^{(r)}.

### Example Ray Launching for Estimation of a Wireless Channel Using Machine Learning Models

In some aspects, to launch rays used to estimate a wireless channel using machine learning models, ray launching stage 210 can use a “blind” launching scheme. In a “blind” launching scheme, a transmitter can be approximated as an icosphere, as discussed above, and rays can be generated and transmitted from the transmitter along vertex normals associated with each surface of the icosphere. A “blind” launching scheme generally results in some beams reaching a reception ellipsoid representing the receiver in a wireless communication system. However, many beams generated in a “blind” launching scheme may not contribute, or at least may not meaningfully contribute, to the channel impulse response for a received signal at the receiver.

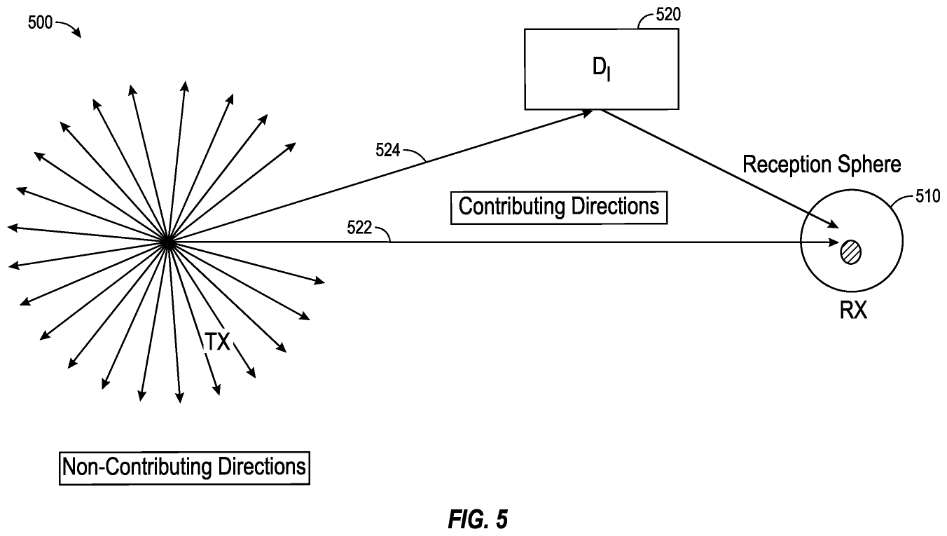

FIG. 5 illustrates an example 500 of “blind” launching of rays from a transmitter to a receiver in a spatial environment. It should be noted that FIG. 5 illustrates a simplified example in two dimensions and that the techniques discussed herein can be used to launch rays in a three-dimensional space. As illustrated in example 500, a transmitter launches a plurality of rays omnidirectionally, and only a subset of these rays may actually contribute to the channel impulse response for a received signal at the receiver. Generally, a ray which contributes to the channel impulse response for a received signal at the receiver may be a ray which enters a reception ellipsoid 510 with a signal strength above a defined threshold value, while a ray which does not meaningfully contribute to the channel impulse response for the received signal at the receiver may be a ray which enters a reception ellipsoid 510 with a signal strength below the defined threshold value, a ray which reflects off of surfaces in a spatial environment F more than a threshold number of times, a ray which exits an area of interest, or the like.

As illustrated, the rays which contribute to the channel impulse response for the received signal at the receiver may include rays corresponding to LOS and non-LOS components. For example, a first ray 522 may be an LOS component which enters reception ellipsoid 510 directly without reflection or other interactions with surfaces in the spatial environment F. A second ray 524, meanwhile, may be a non-LOS component which enters reception ellipsoid 510 after reflection off of a surface 520 in the spatial environment F.

Because, as illustrated in FIG. 5, a small number of rays relative to the total number of rays launched from the transmitter may contribute to the channel impulse response for a received signal at the receiver, compute resource utilization may be reduced by transmitting rays along paths that meaningfully contribute to the channel impulse response for the received signal. By doing so, compute resources, such as processing time and memory, may not be wasted on estimating the propagation of a large number of rays which will not meaningfully contribute to the channel impulse response for the received signal. To allow for rays to be emitted along paths that meaningfully contribute to the channel impulse response for the received signal, aspects of the present disclosure can use a ray launching neural network that is trained to learn which directions meaningfully contribute to a channel impulse response, given the location of a transmitter xₜₓ, the location of a receiver xᵣₓ, and the three-dimensional layout of spatial environment F.

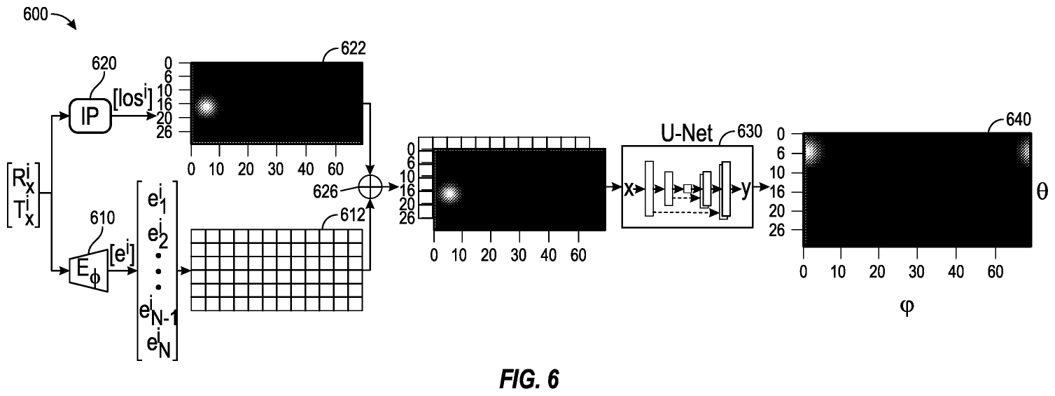

FIG. 6 illustrates an example of a ray launching model 600 which launches rays that contribute to signal reception at a receiver, according to aspects of the present disclosure. Ray launching model 600 may, in some aspects, correspond to ray launching stage 210 illustrated in FIG. 2. Ray launching model 600 generally may be trained to produce a distribution (which may be visualized as a heat map) prioritizing ray directions that meaningfully contribute to the channel impulse response of a received signal at the receiver, given inputs of a three-dimensional layout of spatial environment F, location of the transmitter xₜₓ, and location of the receiver xᵣₓ. Because ray launching model 600 launches rays that contribute to signal reception at the receiver, ray launching model 600 may be trained to deprioritize ray directions that do not meaningfully contribute to the channel impulse response of the received signal. The ray launching model 600, as illustrated may be constructed as a neural network including a trainable embedding module 610, an image prior module 620, and a trainable ray launching module 630.

The embedding module 610 generally is trained to encode inputs of xₜₓ and xᵣₓ (e.g., the locations of the receiver and the transmitter in the spatial environment) into a high-dimensional embedding 612. Generally, the embedding module 610 models the effects that the environment has on the interactions between the receiver and the transmitter in the spatial environment. These interactions, as discussed, may include obstructions between the transmitter and receiver that block LOS and non-LOS components from entering a reception ellipsoid associated with the receiver, reflection points (and the manner by which these reflection points reflect signals), scattering due to various surfaces in the spatial environment, and the like. In some aspects, the embedding module 610 may be a network, such as a multi-layer perceptron (MLP) network, which captures high-frequency features of an interaction between the transmitter and the receiver.

The image prior module 620 incorporates domain information into the ray launching neural network. The image prior module 620 may use an image method technique used for pathfinding in ray tracing systems. Given inputs of the locations of the transmitter and receiver, the image prior module 620 can generate an output prior 622 which may represent an LOS prior associated with the LOS direction between the transmitter and receiver and, in some aspects, first- and second-order virtual anchor locations. These virtual anchors may, for example, represent transmitters outside of the spatial environment serving as a virtual source of a reflected signal when the reflected signal is modeled as an LOS component at the receiver.

Generally, the output prior 622 of the image prior module 620 may serve as a prior for a ray launching module 630, which uses a combination, generated by combiner 626, of the prior 622 from the image prior module 620 and the embedding 612 from the embedding module 610 and learns deviations, such as obstructions, scattering, reflections, and the like around the prior. In some aspects, the ray launching module 630 may be a U-Net or other convolutional network. Generally, by fusing an embedding 612 and a prior 622, the ray launching module 630 can model complex interactions, such as scattering and obstructions, without concerning itself with simpler interactions such as LOS components (whether real or virtual) in the spatial environment. The output 640 of the ray launching module 630 may be a probabilistic heat map, generated over the directions along which rays may be transmitted (or emitted) from the transmitter, illustrating the relevance of each ray to the channel impulse response at a reception ellipsoid corresponding to the receiver. This probabilistic heat map, which may be in a two-dimensional space, may be the result of flattening a spherical probabilistic heat map rendered on a transmission ellipsoid associated with the transmitter. However, it should be recognized that other techniques for representing spherical signals, such as spherical harmonics, spherical convolutional neural networks (CNNs), or the like can also or alternatively be used to model the probabilistic heat map rendered on the transmission ellipsoid associated with the transmitter.

Generally, a number of ray launching directions may be sampled from output 640 of the ray launching module 630 using various techniques, such as a Gumbel-Softmax technique. These sampled ray launching directions may then be provided as input to a ray tracer (e.g., ray propagation estimation stage 220 illustrated in FIG. 2) which, as discussed above, estimates the propagation of a ray associated with each sampled ray launching direction and uses the estimated propagation to estimate a channel given the locations of the transmitter and receiver in a spatial environment and the three-dimensional layout of the spatial environment.

### Example Channel Rendering Using Machine Learning Models

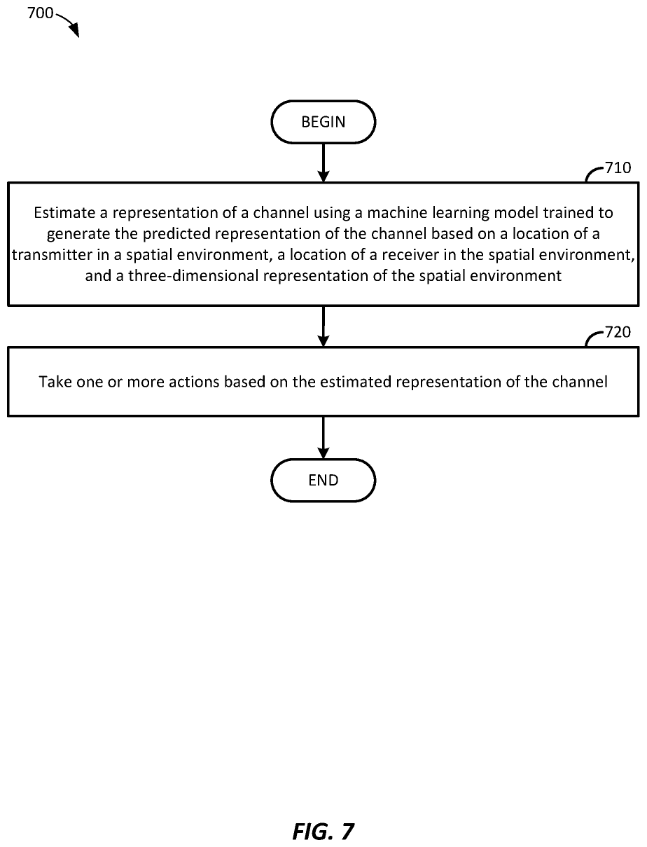

FIG. 7 illustrates example operations 700 for estimating a layout of a spatial area based on a machine learning model and an input data set of multidimensional samples from the spatial area, according to aspects of the present disclosure.

As illustrated, operations 700 begin at block 710, where a representation of a channel is estimated using a machine learning model. Generally, the machine learning model may be trained to generate the estimated representation of the channel based on a location of a transmitter in a spatial environment, a location of a receiver in the spatial environment, and a three-dimensional representation of the spatial environment.

In some aspects, the machine learning model is trained to generate the estimated representation of the channel based on “blind” launching of rays. As discussed, “blind” launching of rays generally includes transmission of rays uniformly sampled on an ellipsoid (e.g., a sphere) representing the transmitter. The uniform sampling may be, for example, a uniform sampling of faces on an icosphere approximating the ellipsoid representing the transmitter.

In some aspects, the machine learning model is trained to generate the estimated representation of the channel based on the location of the transmitter and the location of the receiver in the spatial environment. To do so, the machine learning model can use a ray launching model configured to estimate the set of rays. This ray launching model generally includes an embedding model, an image prior model, and a ray launching model. The embedding model is generally trained to generate an embedding representing a relationship between the location of the transmitter and the location of the receiver in the spatial environment. The image prior model generally encodes the location of the transmitter and the location of the receiver into line-of-sight information. Finally, the ray launching model is generally trained to identify a plurality of rays to launch towards the receiver based on the embedding representing the relationship between the locations of the transmitter and the receiver and the line-of-sight information generated by the image prior model. In some aspects, the ray launching model may be a model trained to generate a probabilistic heat map over an ellipsoid around the location of the transmitter, flattened over a two-dimensional grid.

In some aspects, the machine learning model includes a first sub-model configured to estimate signal attenuation due to reflections off surfaces in the spatial environment and a second sub-model configured to estimate signal attenuation due to free space in the spatial environment. The first sub-model may be further configured to estimate a distance over which signals propagate relative to a transmission source or reflection point in the spatial environment.

In some aspects, estimating the representation of the channel includes estimating a set of vectors representing each ray of a plurality of rays in the channel. Each vector in the set of vectors may represent propagation of the ray over time. Generally, each vector includes position information, direction information, gain information, time of flight information, and a validity score indicating whether a ray contributes to the channel. A respective set of vectors representing a respective ray of the plurality of rays may be terminated based a location of the ray intersecting with the location of the receiver, or power of the ray falling below a threshold value. As discussed, termination of a set of vectors may indicate that a signal no longer has sufficient strength to meaningfully contribute to an impulse response for the channel at a reception ellipsoid around the receiver.

In some aspects, the machine learning model comprises a model trained to minimize a loss between an estimated state of the channel and an actual state of the channel over time.

At block 720, operations 700 proceed with taking one or more actions based on the estimated representation of the channel. In some aspects, the taking one or more actions comprises generating a graphical rendering of the estimated representation of the channel in the three-dimensional representation of the spatial environment. In some aspects, the taking one or more actions comprises selecting one or more beams for communications between the transmitter and the receiver based on the estimated representation of the channel. In some aspects, the taking one or more actions comprises detecting presence and location of objects in the spatial environment based on the estimated representation of the channel. In some aspects, the taking one or more actions comprises identifying material properties of the spatial environment based on the estimated representation of the channel.

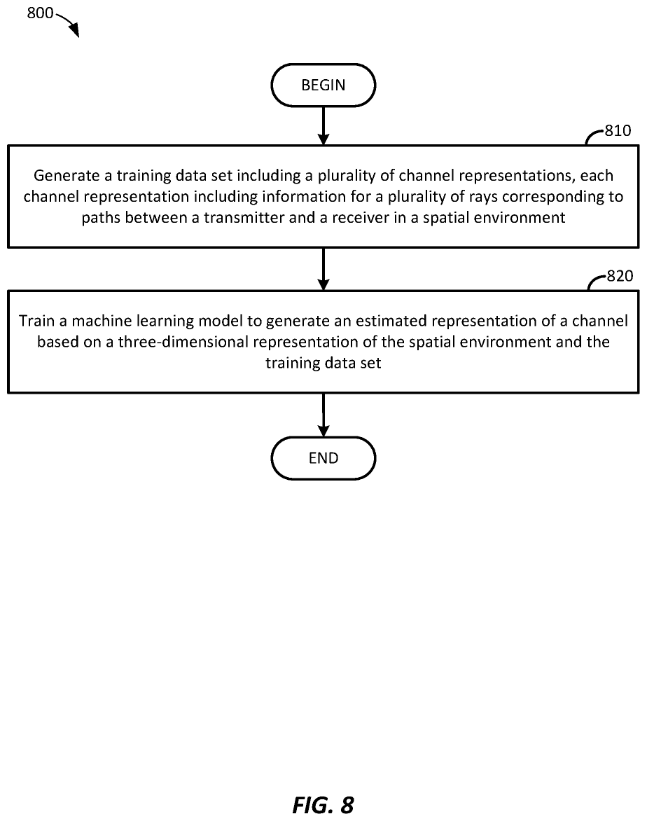

FIG. 8 depicts example operations 800 for training a machine learning model to estimate a layout of a spatial area based on an input data set of multidimensional samples from the spatial area, according to aspects of the present disclosure.

As illustrated, operations 800 begin at block 810, where a training data set including a plurality of channel representations is generated. Each channel representation generally includes information for a plurality of rays corresponding to paths between a transmitter and a receiver in a spatial environment.

In some aspects, each ray of the plurality of rays is represented by a set of vectors representing propagation of the ray over time. Each vector generally includes one or more of position information, direction information, gain information, time of flight information, or a validity score indicating whether a ray contributes to the channel. In some aspects, generating the training data set comprises generating a matrix over the plurality of rays with a mask configured to mask vectors in the matrix associated with validity scores indicating that the ray does not contribute to the channel.

In some aspects, the training data set includes channel representations associated with spatial environments having different surface attenuation and reflection characteristics. By including information from spatial environments having different surface attenuation and reflection characteristics, the resulting model may be usable in a variety of spatial environments and may not be tightly coupled with a specific layout of a spatial environment or specific materials used to build the spatial environment.

At block 820, operations 800 proceed with training a machine learning model to generate an estimated representation of a channel based on a three-dimensional representation of the spatial environment and the training data set.

In some aspects, the machine learning model includes a first sub-model configured to estimate signal attenuation due to reflections off surfaces in the spatial environment and a second sub-model configured to estimate signal attenuation due to free space in the spatial environment. The first sub-model may be further configured to estimate a distance over which signals propagate relative to a transmission source or reflection point in the spatial environment. In some aspects, the machine learning model may further be trained to generate a graphical rendering of the estimated representation of the channel in the three-dimensional representation of the spatial environment.

In some aspects, the estimated representation of the channel may include a set of vectors associated with each ray of a plurality of rays having a contribution to the channel exceeding a threshold contribution.

In some aspects, the machine learning model is trained based on minimizing a loss between an estimated state of the channel and an actual state of the channel over time. This loss, for example, may be a Chamfer distance or other distance between the estimated state of the channel and the actual state of the channel.

In some aspects, the training data set includes a training data set of rays uniformly sampled on an ellipsoid (e.g., sphere) representing the transmitter.

In some aspects, operations 800 further include training a ray launching model to generate a set of rays based on a location of the transmitter and a location of the receiver in the spatial environment. This ray launching model generally includes an embedding model, an image prior model, and a ray launching model. The embedding model is generally trained to generate an embedding representing a relationship between the location of the transmitter and the location of the receiver in the spatial environment. The image prior model generally encodes the location of the transmitter and the location of the receiver into line-of-sight information. Finally, the ray launching model is generally trained to identify a plurality of rays to launch towards the receiver based on the embedding representing the relationship between the locations of the transmitter and the receiver and the line-of-sight information generated by the image prior model. In some aspects, the ray launching model may be a model trained to generate a probabilistic heat map over an ellipsoid (e.g., sphere) around the location of the transmitter, flattened over a two-dimensional grid. In some aspects, the ray launching model may be trained based on aggregation of rays determined to have propagated to locations within a reception ellipsoid (e.g., sphere) defined by a center point and a radius from the center point.

### Example Processing Systems for Channel Rendering Using Machine Learning Models

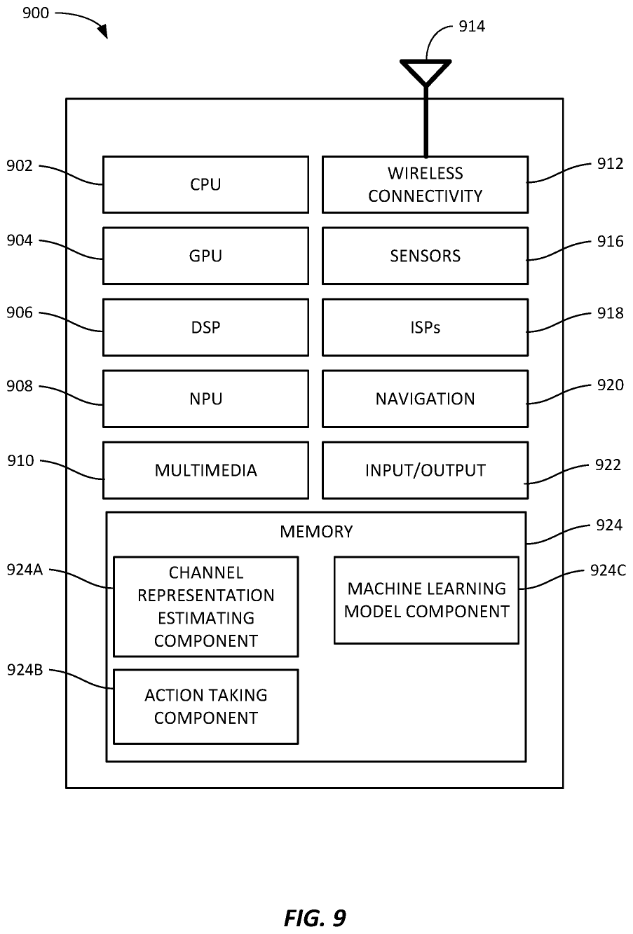

FIG. 9 depicts an example processing system 900 for estimating a channel in a spatial environment based on a machine learning model, such as described herein for example with respect to FIG. 7.

Processing system 900 includes a central processing unit (CPU) 902, which in some examples may be a multi-core CPU. Instructions executed at the CPU 902 may be loaded, for example, from a program memory associated with the CPU 902 or may be loaded from a memory 924.

Processing system 900 also includes additional processing components tailored to specific functions, such as a graphics processing unit (GPU) 904, a digital signal processor (DSP) 906, a neural processing unit (NPU) 908, a multimedia processing unit 910, a wireless connectivity component 912.

An NPU, such as NPU 908, is generally a specialized circuit configured for implementing all the necessary control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPUs), neural network processor (NNP), intelligence processing unit (IPU), vision processing unit (VPU), or graph processing unit.

NPUs, such as NPU 908, are configured to accelerate the performance of common machine learning tasks, such as image classification, machine translation, object detection, and various other estimative models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong estimation involves propagating back through the layers of the model and determining gradients to reduce the estimation error.

NPUs designed to accelerate inference are generally configured to operate on complete models. Such NPUs may thus be configured to input a new piece of data and rapidly process it through an already trained model to generate a model output (e.g., an inference).

In one implementation, NPU 908 is a part of one or more of CPU 902, GPU 904, and/or DSP 906.

In some examples, wireless connectivity component 912 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 912 is further connected to one or more antennas 914.

Processing system 900 may also include one or more sensor processing units 916 associated with any manner of sensor, one or more image signal processors (ISPs) 918 associated with any manner of image sensor, and/or a navigation processor 920, which may include satellite-based positioning system components (e.g., GPS or GLONASS) as well as inertial positioning system components.

Processing system 900 may also include one or more input and/or output devices 922, such as screens, touch-sensitive surfaces (including touch-sensitive displays), physical buttons, speakers, microphones, and the like.

In some examples, one or more of the processors of processing system 900 may be based on an ARM or RISC-V instruction set.

Processing system 900 also includes memory 924, which is representative of one or more static and/or dynamic memories, such as a dynamic random access memory, a flash-based static memory, and the like. In this example, memory 924 includes computer-executable components, which may be executed by one or more of the aforementioned processors of processing system 900.

In particular, in this example, memory 924 includes channel representation estimating component 924A, action taking component 924B, and machine learning model component 924C. The depicted components, and others not depicted, may be configured to perform various aspects of the methods described herein.

Generally, processing system 900 and/or components thereof may be configured to perform the methods described herein.

Notably, in other aspects, aspects of processing system 900 may be omitted, such as where processing system 900 is a server computer or the like. For example, multimedia processing unit 910, wireless connectivity component 912, sensor processing units 916, ISPs 918, and/or navigation processor 920 may be omitted in other aspects. Further, aspects of processing system 900 may be distributed, such as training a model and using the model to generate inferences, such as user verification estimations.

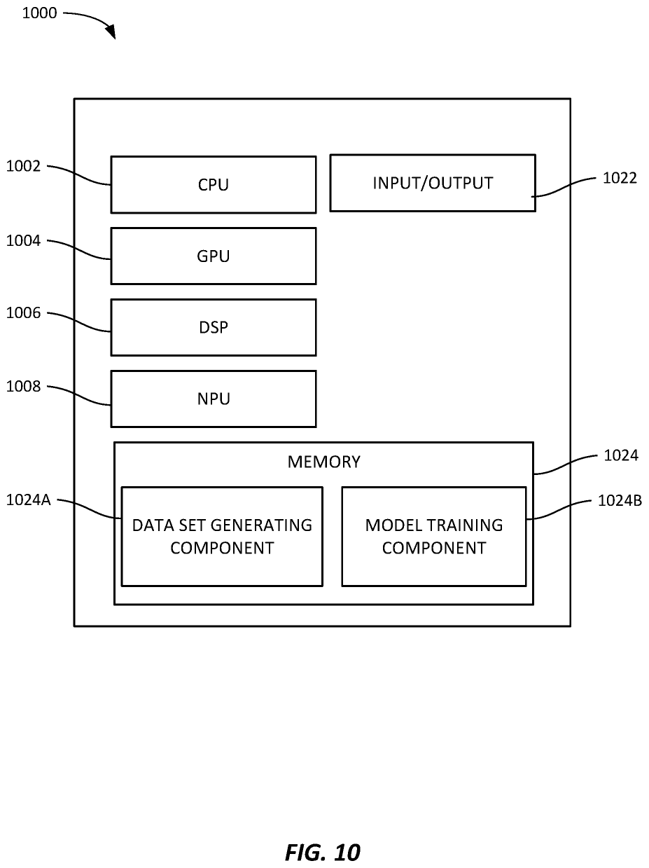

FIG. 10 depicts an example processing system 1000 for training a machine learning model to estimate a channel in a spatial environment, such as described herein for example with respect to FIG. 8.

Processing system 1000 includes a central processing unit (CPU) 1002, which in some examples may be a multi-core CPU. Processing system 1000 also includes additional processing components tailored to specific functions, such as a graphics processing unit (GPU) 1004, a digital signal processor (DSP) 1006, and a neural processing unit (NPU) 1008. CPU 1002, GPU 1004, DSP 1006, NPU 1008, and input and/or output devices 1022 may be similar to CPU 1002, GPU 1004, DSP 1006, NPU 1008, and input and/or output devices 1022 discussed above with respect to FIG. 8.

In some examples, wireless connectivity component 1012 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 1012 may be further connected to one or more antennas (not shown).

In some examples, one or more of the processors of processing system 1000 may be based on an ARM or RISC-V instruction set.

Processing system 1000 also includes memory 1024, which is representative of one or more static and/or dynamic memories, such as a dynamic random access memory, a flash-based static memory, and the like. In this example, memory 1024 includes computer-executable components, which may be executed by one or more of the aforementioned processors of processing system 1000.

In particular, in this example, memory 1024 includes data set generating component 1024A and model training component 1024B. The depicted components, and others not depicted, may be configured to perform various aspects of the methods described herein.

Generally, processing system 1000 and/or components thereof may be configured to perform the methods described herein.

### Example Clauses

Implementation details of various aspects are described in the following numbered clauses.

Clause 1: A computer-implemented method, comprising: estimating a representation of a channel using a machine learning model trained to generate the estimated representation of the channel based on a location of a transmitter in a spatial environment, a location of a receiver in the spatial environment, and a three-dimensional representation of the spatial environment; and taking one or more actions based on the estimated representation of the channel.

Clause 2: The method of Clause 1, wherein the machine learning model is trained to generate the estimated representation of the channel based on transmission of rays uniformly sampled on an ellipsoid representing the transmitter.

Clause 3: The method of Clause 1 or 2, wherein the machine learning model is trained to generate the estimated representation of the channel based on a set of rays selected based on the location of the transmitter and the location of the receiver in the spatial environment.

Clause 4: The method of Clause 3, wherein: the machine learning model comprises a ray launching model configured to estimate the set of rays, and the ray launching model comprises: an embedding model trained to generate an embedding representing a relationship between the location of the transmitter and the location of the receiver in the spatial environment; an image prior model that encodes the location of the transmitter and the location of the receiver in the spatial environment into line-of-sight information; and a ray launching module trained to identify a plurality of rays to launch towards the receiver based on the embedding representing the relationship between the location of the transmitter and the location of the receiver in the spatial environment and the line-of-sight information.

Clause 5: The method of Clause 3 or 4, wherein the ray launching model comprises a model trained to generate a probabilistic heat map over an ellipsoid around the location of the transmitter, flattened over a two-dimensional grid.

Clause 6: The method of any of Clauses 1 through 5, wherein the machine learning model comprises a first sub-model configured to estimate signal attenuation due to reflections off surfaces in the spatial environment and a second sub-model configured to estimate signal attenuation due to free space in the spatial environment.

Clause 7: The method of Clause 6, wherein the first sub-model is further configured to estimate a distance over which signals propagate relative to a transmission source or reflection point in the spatial environment.

Clause 8: The method of any of Clauses 1 through 7, wherein: estimating the representation of the channel using the machine learning model comprises estimating a set of vectors representing each ray of a plurality of rays in the channel, each vectors in the set of vectors representing propagation of the ray over time, and each vector includes position information, direction information, gain information, time of flight information, and a validity score indicating whether a ray contributes to the channel.

Clause 9: The method of Clause 8, wherein a respective set of vectors representing a respective ray of the plurality of rays is terminated based on one of: a location of the ray intersecting with the location of the receiver, or power of the ray falling below a threshold value.

Clause 10: The method of any of Clauses 1 through 9, wherein the machine learning model comprises a model trained to minimize an LOS between an estimated state of the channel and an actual state of the channel over time.

Clause 11: The method of any of Clauses 1 through 10, wherein the taking one or more actions comprises generating a graphical rendering of the estimated representation of the channel in the three-dimensional representation of the spatial environment.

Clause 12: The method of any of Clauses 1 through 11, wherein the taking one or more actions comprises selecting one or more beams for communications between the transmitter and the receiver based on the estimated representation of the channel.

Clause 13: The method of any of Clauses 1 through 12, wherein the taking one or more actions comprises detecting presence and location of objects in the spatial environment based on the estimated representation of the channel.

Clause 14: The method of any of Clauses 1 through 13, wherein the taking one or more actions comprises identifying material properties of the spatial environment based on the estimated representation of the channel.

Clause 15: A computer-implemented method, comprising: generating a training data set including a plurality of channel representations, each channel representation including information for a plurality of rays corresponding to paths between a transmitter and a receiver in a spatial environment; and training a machine learning model to generate an estimated representation of a channel based on a three-dimensional representation of the spatial environment and the training data set.

Clause 16: The method of Clause 15, wherein: each ray of the plurality of rays is represented by a set of vectors representing propagation of the ray over time, and each vector includes one or more of position information, direction information, gain information, time of flight information, or a validity score indicating whether a ray contributes to the channel.

Clause 17: The method of Clause 16, wherein generating the training data set comprises generating a matrix over the plurality of rays with a mask configured to mask vectors in the matrix associated with validity scores indicating that the ray does not contribute to the channel.

Clause 18: The method of any of Clauses 15 through 17, wherein the machine learning model comprises a first sub-model configured to estimate signal attenuation due to free space in the spatial environment and a second sub-model configured to estimate signal attenuation due to reflections off surfaces in the spatial environment.

Clause 19: The method of any of Clauses 15 through 18, wherein the machine learning model is further trained to generate a graphical rendering of the estimated representation of the channel in the three-dimensional representation of the spatial environment.

Clause 20: The method of any of Clauses 15 through 19, wherein the estimated representation of the channel comprises a set of vectors associated with each ray of a plurality of rays having a contribution to the channel exceeding a threshold contribution.

Clause 21: The method of any of Clauses 15 through 20, wherein training the machine learning model comprises training the machine learning model to minimize an LOS between an estimated state of the channel and an actual state of the channel over time.

Clause 22: The method of Clause 21, wherein the loss comprises a Chamfer distance between an estimated state of the channel and an actual state of the channel over time.

Clause 23: The method of any of Clauses 15 through 22, wherein the training data set comprises a training data set of rays uniformly sampled on an ellipsoid representing the transmitter.

Clause 24: The method of any of Clauses 15 through 23, further comprising training a ray launching model to generate a set of rays based on a location of the transmitter and a location of the receiver in the spatial environment.

Clause 25: The method of Clause 24, wherein the ray launching model comprises: an embedding model trained to generate an embedding representing a relationship between the location of the transmitter and the location of the receiver in the spatial environment; an image prior model that encodes the location of the transmitter and the location of the receiver in the spatial environment into line-of-sight information; and a ray launching module trained to identify the plurality of rays to launch towards the receiver based on the embedding representing the relationship between the location of the transmitter and the location of the receiver in the spatial environment and the line-of-sight information.

Clause 26: The method of Clause 25, wherein the ray launching model comprises a model trained to generate a probabilistic heat map over an ellipsoid around the location of the transmitter, flattened over a two-dimensional grid.

Clause 27: The method of Clause 25 or 26, wherein the ray launching model comprises a model trained based on aggregation of rays determined to have propagated to locations within a reception sphere defined by a center point and a radius from the center point.

Clause 28: The method of any of Clauses 15 through 27, wherein the training data set includes channel representations associated with spatial environments having different surface attenuation and reflection characteristics.

Clause 29: A processing system, comprising: a memory comprising computer-executable instructions; and one or more processors configured to execute the computer-executable instructions and cause the processing system to perform a method in accordance with any of Clauses 1-28.

Clause 30: A processing system, comprising means for performing a method in accordance with any of Clauses 1-28.

Clause 31: A non-transitory computer-readable medium comprising computer-executable instructions that, when executed by one or more processors of a processing system, cause the processing system to perform a method in accordance with any of Clauses 1-28.

Clause 32: A computer program product embodied on a computer-readable storage medium comprising code for performing a method in accordance with any of Clauses 1-28.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
estimating a representation of a channel using a machine learning model trained to generate the estimated representation of the channel based on a location of a transmitter in a spatial environment, a location of a receiver in the spatial environment, and a three-dimensional representation of the spatial environment; and
taking one or more actions based on the estimated representation of the channel.

2. The method of claim 1, wherein the machine learning model is trained to generate the estimated representation of the channel based on transmission of rays uniformly sampled on an ellipsoid representing the transmitter.

3. The method of claim 1, wherein the machine learning model is trained to generate the estimated representation of the channel based on a set of rays selected based on the location of the transmitter and the location of the receiver in the spatial environment.

4. The method of claim 3, wherein:
the machine learning model comprises a ray launching model configured to estimate the set of rays, and
the ray launching model comprises:
an embedding model trained to generate an embedding representing a relationship between the location of the transmitter and the location of the receiver in the spatial environment;
an image prior model that encodes the location of the transmitter and the location of the receiver in the spatial environment into line-of-sight information; and
a ray launching module trained to identify a plurality of rays to launch towards the receiver based on the embedding representing the relationship between the location of the transmitter and the location of the receiver in the spatial environment and the line-of-sight information.

5. The method of claim 3, wherein the ray launching model comprises a model trained to generate a probabilistic heat map associated with an ellipsoid around the location of the transmitter, flattened over a two-dimensional grid.

6. The method of claim 1, wherein the machine learning model comprises a first sub-model configured to estimate signal attenuation due to reflections off surfaces in the spatial environment and a second sub-model configured to estimate signal attenuation due to free space in the spatial environment.

7. The method of claim 6, wherein the first sub-model is further configured to estimate a distance over which signals propagate relative to a transmission source or reflection point in the spatial environment.

8. The method of claim 1, wherein:
estimating the representation of the channel using the machine learning model comprises estimating a set of vectors representing each ray of a plurality of rays in the channel, each set of vectors representing propagation of the ray over time; and
each vector includes position information, direction information, gain information, time of flight information, and a validity score indicating whether a ray contributes to the channel.

9. The method of claim 8, wherein a respective set of vectors representing a respective ray of the plurality of rays is terminated based on one of: a location of the ray intersecting with the location of the receiver, or a power of the ray falling below a threshold value.

10. The method of claim 1, wherein the machine learning model is trained to minimize an LOS between an estimated state of the channel and an actual state of the channel over time.

11. The method of claim 1, wherein the taking the one or more actions comprises generating a graphical rendering of the estimated representation of the channel in the three-dimensional representation of the spatial environment.

12. The method of claim 1, wherein the taking the one or more actions comprises selecting one or more beams for communications between the transmitter and the receiver based on the estimated representation of the channel.

13. The method of claim 1, wherein the taking the one or more actions comprises detecting presence and location of objects in the spatial environment based on the estimated representation of the channel.

14. The method of claim 1, wherein the taking the one or more actions comprises identifying material properties of the spatial environment based on the estimated representation of the channel.

15. A computer-implemented method, comprising:
generating a training data set including a plurality of channel representations, each channel representation including information for a plurality of rays corresponding to paths between a transmitter and a receiver in a spatial environment; and
training a machine learning model to generate an estimated representation of a channel based on a three-dimensional representation of the spatial environment and the training data set.

16. The method of claim 15, wherein:
each ray of the plurality of rays is represented by a set of vectors representing propagation of the ray over time, and
each vector includes one or more of position information, direction information, gain information, time of flight information, or a validity score indicating whether a ray contributes to the channel.

17. The method of claim 16, wherein generating the training data set comprises generating a matrix over the plurality of rays with a mask configured to mask vectors in the matrix associated with validity scores indicating that the ray does not contribute to the channel.

18. The method of claim 15, wherein the machine learning model comprises a first sub-model configured to estimate signal attenuation due to free space in the spatial environment and a second sub-model configured to estimate signal attenuation due to reflections off surfaces in the spatial environment.

19. The method of claim 15, wherein the machine learning model is further trained to generate a graphical rendering of the estimated representation of the channel in the three-dimensional representation of the spatial environment.

20. The method of claim 15, wherein the estimated representation of the channel comprises a set of vectors associated with each ray of the plurality of rays having a contribution to the channel exceeding a threshold contribution.

21. The method of claim 15, wherein training the machine learning model comprises training the machine learning model to minimize an LOS between an estimated state of the channel and an actual state of the channel over time.

22. The method of claim 21, wherein the loss comprises a Chamfer distance between the estimated state of the channel and the actual state of the channel over time.

23. The method of claim 15, wherein the training data set comprises a training data set of rays uniformly sampled on an ellipsoid representing the transmitter.

24. The method of claim 15, further comprising training a ray launching model to generate a set of rays based on a location of the transmitter and a location of the receiver in the spatial environment.

25. The method of claim 24, wherein the ray launching model comprises:
an embedding model trained to generate an embedding representing a relationship between the location of the transmitter and the location of the receiver in the spatial environment;
an image prior model that encodes the location of the transmitter and the location of the receiver in the spatial environment into line-of-sight information; and
a ray launching module trained to identify the plurality of rays to launch towards the receiver based on the embedding representing the relationship between the location of the transmitter and the location of the receiver in the spatial environment and the line-of-sight information.

26. The method of claim 25, wherein the ray launching model comprises a model trained to generate a probabilistic heat map associated with an ellipsoid around the location of the transmitter, flattened over a two-dimensional grid.

27. The method of claim 25, wherein the ray launching model comprises a model trained based on an aggregation of rays determined to have propagated to locations within a reception ellipsoid defined by a center point and a radius from the center point.

28. The method of claim 15, wherein the training data set includes channel representations associated with spatial environments having different surface attenuation and reflection characteristics.

29. A processing system, comprising:
a memory having executable instructions stored thereon; and
a processor configured to execute the executable instructions to cause the processing system to:
estimate a representation of a channel using a machine learning model trained to generate the estimated representation of the channel based on a location of a transmitter in a spatial environment, a location of a receiver in the spatial environment, and a three-dimensional representation of the spatial environment; and
take one or more actions based on the estimated representation of the channel.

30. A processing system, comprising:
a memory having executable instructions stored thereon; and
a processor configured to execute the executable instructions to cause the processing system to:
generate a training data set including a plurality of channel representations, each channel representation including information for a plurality of rays corresponding to paths between a transmitter and a receiver in a spatial environment; and
train a machine learning model to generate an estimated representation of a channel based on a three-dimensional representation of the spatial environment and the training data set.
